(19) United States
(12) Patent Application Publication
(10) Pub. No.: US 2012/0242305 A1
(43) Pub. Date: Sep. 27, 2012

(54) SWITCHING CIRCUIT AND DC-TO-DC CONVERTER

(75) Inventor: Yuichi Goto, Kanagawa-ken (JP)

(73) Assignee: KABUSHIKI KAISHA TOSHIBA, Tokyo (JP)

(21) Appl. No.: 13/237,034

(22) Filed: Sep. 20, 2011

(30) Foreign Application Priority Data
Mar. 22, 2011 (JP) 2011-062756

(51) Int. Cl. G05F 1/46

(52) U.S. Cl. 323/271

(57) ABSTRACT

According to one embodiment, a switching circuit includes a high-side switch, a low-side switch, and a driver. The high-side switch is connected between a power supply terminal and an output terminal. The low-side switch is connected between the output terminal and a ground terminal. The driver is configured to turn off any one of the high-side switch and the low-side switch according to a control signal. The driver is configured to supply a first voltage to a control terminal of one other switch in a first period to turn on the one other switch, and supply a second voltage higher than the first voltage to the control terminal of the one other switch after the first period.

### CROSS-REFERENCE TO RELATED APPLICATIONS

This application is based upon and claims the benefit of priority from the prior Japanese Patent Application No. 2011-062756, filed on Mar. 22, 2011; the entire contents of which are incorporated herein by reference.

### FIELD

Embodiments described herein relate generally to a switching circuit and a DC-to-DC converter.

### BACKGROUND

Switching circuits are widely used for output circuits to drive an inductive load. For example, in a step-down DC-to-DC converter, an inductor is driven using a switching circuit including a high-side switch and a low-side switch.

When the high-side switch is off, a current flowing through the low-side switch. When the low-side switch turns off and the high-side switch turns on, the recovery current of the parasitic diode of the low-side switch flowing through the high-side switch. Thus, when it is desired to improve efficiency by increasing the speed of switching or using a device with a low ON resistance, the recovery current is also increased, resulting in a factor to produce switching noise and a factor to reduce operation efficiency. It is likely that a device with a low ON resistance is destructed when an output terminal is short-circuited.

### BRIEF DESCRIPTION OF THE DRAWINGS

FIG. 1 is a circuit diagram illustrating a configuration of a switching circuit according to a first embodiment;

FIG. 2A to FIG. 2G are timing charts of main signals of the switching circuit shown in FIG. 1;

FIG. 3 is a characteristic diagram illustrating a relationship between a gate-source voltage Vgs and an ON resistance Ron;

FIG. 4A and FIG. 4B are characteristic diagrams illustrating states of the high-side switch;

FIG. 5 is a circuit diagram illustrating a configuration of a switching circuit according to a second embodiment;

FIG. 6A to FIG. 6H are timing charts of main signals of the switching circuit shown in FIG. 5;

FIG. 7 is a circuit diagram illustrating another configuration of a switching circuit according to the second embodiment;

FIG. 8A to FIG. 8G are timing charts of main signals of the switching circuit shown in FIG. 7;

FIG. 9 is a circuit diagram illustrating a configuration of a DC-to-DC converter according to a third embodiment;

FIG. 10A to FIG. 10G are timing charts of main signals of the DC-to-DC converter shown in FIG. 9; and

FIG. 11A to FIG. 11G are other timing charts of main signals of the DC-to-DC converter shown in FIG. 9.

### DETAILED DESCRIPTION

In general, according to one embodiment, a switching circuit includes a high-side switch, a low-side switch, and a driver. The high-side switch is connected between a power supply terminal and an output terminal. The low-side switch is connected between the output terminal and a ground terminal. The driver is configured to turn off any one of the high-side switch and the low-side switch according to a control signal. The driver is configured to supply a first voltage to a control terminal of one other switch in a first period to turn on the one other switch, and supply a second voltage higher than the first voltage to the control terminal of the one other switch after the first period.

Hereinafter, embodiments will now be described in detail with reference to the drawings. In the specification and drawings, components similar to those described or illustrated in a drawing thereinabove are marked with like reference numerals, and a detailed description is omitted as appropriate.

### First Embodiment

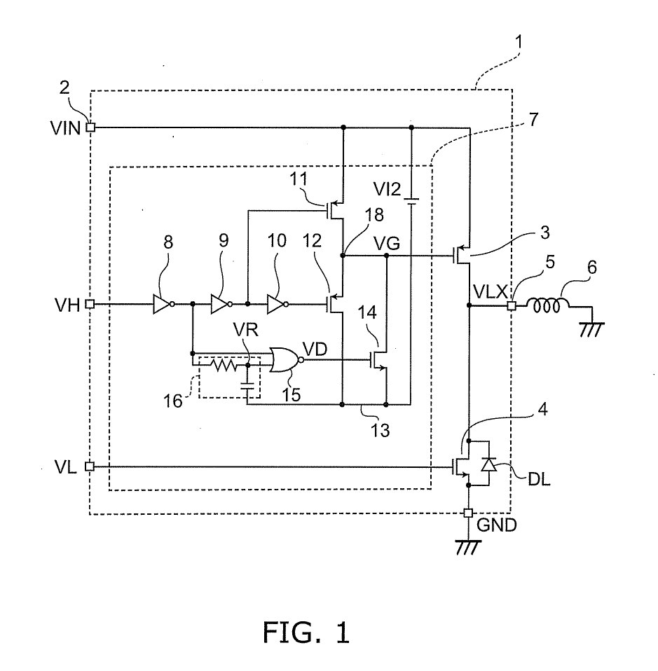

FIG. 1 is a circuit diagram illustrating the configuration of a switching circuit according to a first embodiment.

In a switching circuit 1, a high-side switch 3 is connected between a power supply terminal 2 and an output terminal 5. A low-side switch 4 is connected between the output terminal 5 and a ground terminal GND. The high-side switch 3 and the low-side switch 4 are connected in series to each other. An inductive load 6 is connected to the output terminal 5.

A driver 7 generates signals to control the high-side switch 3 and the low-side switch 4. The driver 7 turns on or off the high-side switch 3 and the low-side switch 4 according to a high-side control signal VH and a low-side control signal VL externally inputted.

When the high-side switch 3 is on and the low-side switch 4 is off, the output terminal 5 is electrically connected to the power supply terminal 2. In this connection, the voltage of the output terminal 5, i.e. an output voltage VLX is made at a supply voltage VIN supplied to the power supply terminal 2. A current flows through the inductive load 6, and energy is supplied from a power supply through the power supply terminal 2.

When the high-side switch 3 is off and the low-side switch 4 is on, the output terminal 5 is electrically connected to the ground terminal GND. In this connection, the output voltage VLX is made at 0 V. A regenerated current flows through the inductive load 6 to reduce energy.

The switching circuit 1 drives the inductive load 6 according to the high-side control signal VH and the low-side control signal VL. In FIG. 1, although an inductor is illustrated for the inductive load 6, it may be the inductor of a DC-to-DC converter or the actuator of a motor or the like, for example.

Next, elements will be described.

The high-side switch 3 is a P-channel MOSFET (referred to as a PMOS below); the source thereof is connected to the power supply terminal 2, and the drain is connected to the output terminal 5. A gate (a control terminal) 18 of the high-side switch 3 is connected to the driver 7. The high-side switch 3 includes a parasitic diode, not shown.

The low-side switch 4 is an N-channel MOSFET (referred to as an NMOS below); the source thereof is connected to the ground terminal GND, and the drain is connected to the output terminal 5. The gate of the low-side switch 4 is connected to the driver 7. The low-side switch 4 includes a parasitic diode DL.

In the driver 7, the high-side control signal VH is inputted to a first transistor 11 and a second transistor 12 through inverters (NOT circuits, referred to as INVs below) 8, 9, and 10. The first and second transistors 11 and 12 are PMOSs, and connected in series between the power supply terminal 2 and an internal power supply line 13.

The source of the first transistor 11 is connected to the power supply terminal 2, and the drain is connected to the control terminal 18. The gate of the first transistor 11 is connected to the output of the INV 9. The source of the second transistor 12 is connected to the control terminal 18, and the drain is connected to the internal power supply line 13. The gate of the second transistor 12 is connected to the output of the INV 10.

A third transistor 14 is connected in parallel to the second transistor 12. The third transistor 14 is an NMOS; the drain thereof is connected to the control terminal 18, and the source is connected to the internal power supply line 13. The gate of the third transistor 14 is connected to the output of a NOR (NOT circuit of a logical sum) 15.

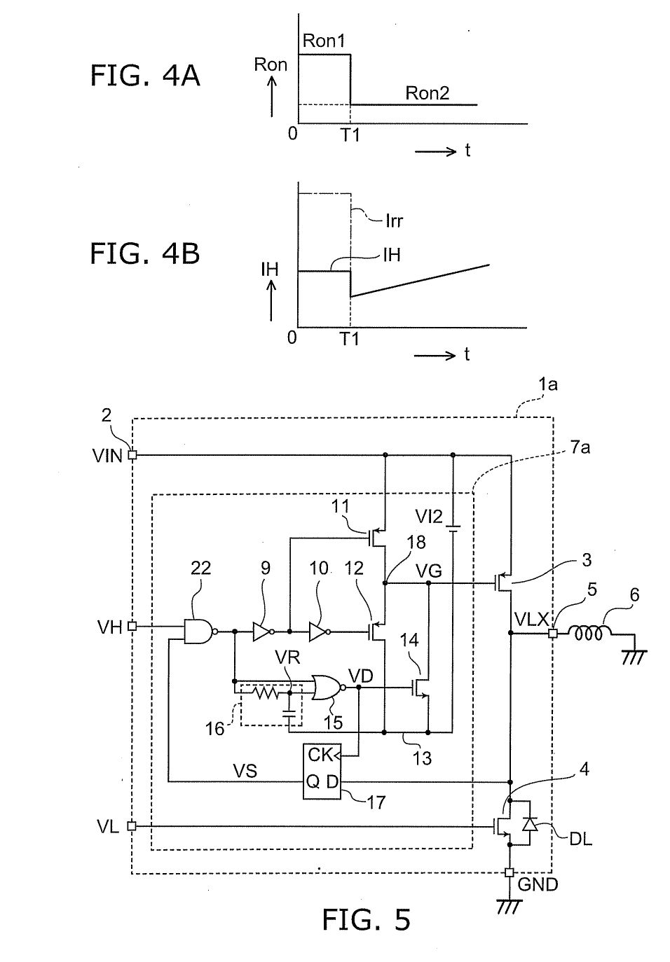

The NOR 15 generates an OR (logical sum) signal, (a signal VD) between the output of the INV 8 and a signal VR that the output of the INV 8 is delayed at a delay circuit 16. The delay circuit 16 includes a resistor and a capacitor. The signal VD is a signal that the rising edge of the output of the INV 8 is unchanged and only the falling edge is delayed and inverted. As explained in FIG. 2A to FIG. 2G, FIG. 4A, and FIG. 4B, a delay time is set to a first period T1 that is almost equal to a reverse recovery time Trr of the parasitic diode DL of the low-side switch 4.

The internal power supply line 13 is supplied with a voltage −VI2 with respect to the power supply terminal 2. VI2 is supplied as an internal supply voltage to the logic circuits such as the INVs 8, 9, and 10 in the inside of the driver 7. The logic circuits in the inside of the driver 7 operate based on the potential of the internal power supply line 13.

As described above, the first transistor 11, the second transistor 12, and the third transistor 14 are connected to the control terminal 18. As explained in FIG. 2A to FIG. 2G, the driver 7 controls a gate voltage (the voltage of the control terminal) VG of the high-side switch 3 according to the high-side control signal VH and the output voltage VLX. The driver 7 outputs the low-side control signal VL to the gate of the low-side switch 4 as the logic is unchanged.

Next, the operation of the switching circuit 1 will be described.

FIG. 2A to FIG. 2G are timing charts of the main signals of the switching circuit shown in FIG. 1. FIG. 2A shows the high-side control signal VH, FIG. 2B shows the low-side control signal VL, FIG. 2C shows the signal VR, FIG. 2D shows the signal VD, FIG. 2E shows the gate voltage VG, FIG. 2F shows the output voltage VLX, and FIG. 2G shows a high-side current IH.

In FIG. 2B, indications ON and OFF express that the low-side switch 4 is controlled to be on or off, respectively. In FIG. 2E, indications ON and OFF express that the high-side switch 3 is controlled to be on or off, respectively.

In FIG. 2A to FIG. 2G, the case is illustrated where square waves periodically repeating high level and low level are inputted for the high-side control signal VH (FIG. 2A). The low-side control signal VL is a signal that the high-side control signal VH is inverted (FIG. 2B). It is noted that a dead time provided for preventing the high-side switch 3 and the low-side switch 4 from being turned on at the same time is omitted.

When the high-side control signal VH is at low level and the low-side control signal VL is at high level (FIG. 2A and FIG. 2B), the high-side switch 3 is off, and the low-side switch 4 is on. In this state, the output voltage VLX is at low level (FIG. 2F). The signal VD is at low level (FIG. 2D). The regenerated current of the inductive load 6 flows through the low-side switch 4.

When the high-side control signal VH is changed from low level to high level (FIG. 2A), the low-side control signal VL is changed from high level to low level (FIG. 2B). The low-side switch 4 is turned off, and the regenerated current flowing through the low-side switch 4 flows through the parasitic diode DL.

Since the signal VD is delayed by the first period T1 with respect to the high-side control signal VH, the signal VD is at low level (FIG. 2D).

The first transistor 11 is turned off, the second transistor 12 is turned on, and the third transistor 14 is turned off. Since the second transistor 12 is a source follower output, the gate voltage VG of the high-side switch 3 is made at a first voltage V1 higher than the potential of the internal power supply line 13 by a threshold voltage Vth of the second transistor 12 (FIG. 2E). In FIG. 2E, the gate voltage VG is expressed based on the potential of the power supply terminal 2.

Here, the first voltage V1 is set lower than the internal supply voltage V12. An ON resistance Ron of the high-side switch 3 has a value greater than the value in the case of supplying the internal supply voltage V12. Thus, the reverse current of the parasitic diode DL is restricted to the ON resistance Ron, and flows as the current IH of the high-side switch 3 (a portion surrounded by an alternate long and short dash line R in FIG. 2G).

The signal VR at the output of the delay circuit 16 is decreased according to a time constant (FIG. 2C). In the first period T1, the signal VR is decreased more than the logic threshold voltage of the NOR 15. The signal VD is changed to high level (FIG. 2D). The signal VD is made to a signal that the rising edge of the high-side control signal VH is delayed by the first period T1.

After the first period T1 elapses since the high-side control signal VH is changed to high level, the signal VD is made at high level. At this change, the output voltage VLX is at high level (a portion surrounded by an alternate long and short dash line P in FIG. 2F).

The third transistor 14 is turned on, and the gate voltage VG is made at a second voltage V2=−VI2. The output voltage VLX is increased to the supply voltage VIN (FIG. 2F). At this time, since the first period T1 elapsing, which is almost equal to the reverse recovery time Trr of the parasitic diode DL, the reverse recovery current of the parasitic diode DL is already decreased. The current IH of the high-side switch 3 is almost linearly increased (FIG. 2G).

When the high-side control signal VH is changed to low level and the low-side control signal VL to high level, the high-side switch 3 is turned off and the low-side switch 4 is turned on. The similar operations are repeated after the subsequent cycle.

As described above, when the high-side control signal VH is at low level and the low-side control signal VL is at high level, the driver 7 turns off the high-side switch 3 and turns on the low-side switch 4. Thereby, the regenerated current of the inductive load 6 flows through the low-side switch 4.

When the high-side control signal VH is changed to high level and the low-side control signal VL to low level, the low-side switch 4 is turned off. At the same time, the first voltage V1 is supplied to the control terminal of the high-side switch 3 in the first period T1. Thereby, the reverse recovery current of the parasitic diode DL of the low-side switch 4 restricted to the ON resistance Ron flows as the current IH of the high-side switch 3.

After the first period, the supply voltage VIN is supplied as the second voltage V2 higher than the first voltage V1 to turn on the high-side switch 3. The ON resistance of the high-side switch 3 in this switching is made smaller than the value in the first period T1.

In the switching circuit 1, a gate drive voltage is decreased in the first period T1 in which the high-side switch 3 is changed from off to on, so that the reverse recovery current of the parasitic diode DL is restricted. After the first period T1, the gate drive voltage of the high-side switch 3 is increased at some time when the current flowing through the parasitic diode DL is gone, and the ON resistance is more decreased.

Even in the case where the output terminal 5 and the ground terminal GND are short-circuited to each other in the first period T1, the current IH flowing through the high-side switch 3 takes a value restricted by a relatively high ON resistance.

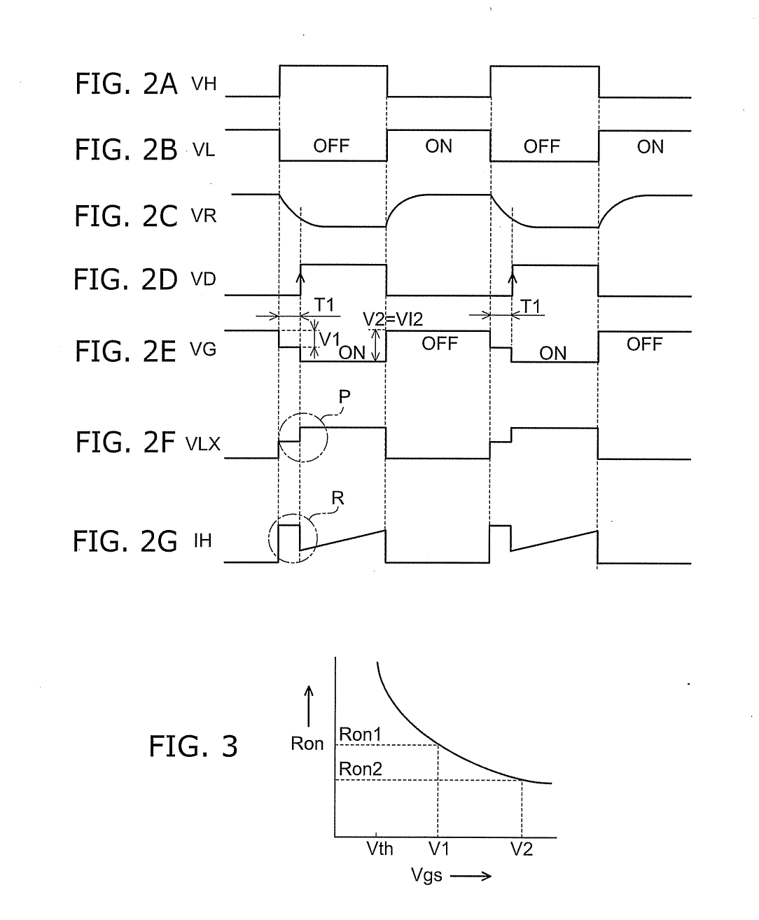

FIG. 3 is a characteristic diagram illustrating a relationship between a gate-source voltage Vgs and an ON resistance Ron.

In FIG. 3, the gate-source voltage Vgs of the high-side switch 3 is plotted on the horizontal axis, and the ON resistance Ron is plotted on the vertical axis for expressing the dependency of the ON resistance Ron on the gate-source voltage Vgs. The voltages express absolute values.

The ON resistance Ron is monotonously decreased with respect to the gate-source voltage Vgs at or above the threshold voltage Vth. Since the gate voltage VG is based on the potential of the power supply terminal 2, the gate voltage VG is equal to the gate-source voltage Vgs of the high-side switch 3. When the gate voltage VG is at the first voltage V1, the ON resistance is at Ron1. When the gate voltage is at the second voltage V2 (=VI2), the ON resistance is at Ron2. Here, |Vgs1|<|Vgs2|, and Ron1>Ron2.

FIG. 4A and FIG. 4B are characteristic diagrams illustrating states of the high-side switch. FIG. 4A shows the ON resistance Ron, and FIG. 4B shows the high-side current IH.

In FIG. 4A, time t is plotted on the horizontal axis, and the ON resistance Ron is plotted on the vertical axis for expressing the time variation of the ON resistance Ron of the high-side switch 3. In FIG. 4B, time t is plotted on the horizontal axis, and the current IH of the high-side switch 3 is plotted on the vertical axis for expressing the time variation of the current IH.

In the case where the high-side control signal VH is changed from low level to high level at time t=0, the ON resistance Ron is made at Ron1 in the first period T1. After the first period T1, the ON resistance Ron is made at Ron2 smaller than Ron1.

The current IH of the high-side switch 3 is restricted to a value smaller than a reverse recovery current Irr of the parasitic diode DL flowing in the case of the ON resistance Ron2 in the first period T1, because of a relatively large ON resistance Ron1.

Consequently, switching noise is reduced, and operation efficiency is improved.

In FIG. 4B, the current IH is illustrated in the case where the first period T1 is equal to the reverse recovery time Trr of the parasitic diode DL. However, the first period T1 may not be equal to the reverse recovery time Trr of the parasitic diode DL.

For example, the first period T1 may be not longer than the reverse recovery time Trr of the parasitic diode DL. In this case, the current IH is restricted in the first period T1 because of a relatively large ON resistance Ron1, and the reverse recovery current Irr of the parasitic diode DL flowing until the reverse recovery time Trr even after the first period T1.

However, the reverse recovery current Irr is made smaller than that in the case where the first period T1 is not set and the ON resistance is set to a small value of Ron2 at time t=0. Thus, switching noise is more reduced, and operation efficiency is more improved than those in the case where the first period T1 is not set. Operation efficiency is improved because a period for which the ON resistance is small is made longer, as compared with the case where the first period T1 is set equal to the reverse recovery time Trr.

The first period T1 may be set longer than the reverse recovery time Trr of the parasitic diode DL. In this case, a relatively large ON resistance Ron1 is kept until the first period T1 elapsing even after the reverse recovery time Trr. However, a reduction in operation efficiency is small if the first period T1 is shorter enough than a period for which the high-side control signal VH is at high level, that is, a period for which the high-side switch 3 is on.

In the switching circuit 1 shown in FIG. 1, the first transistor 11 and the second transistor 12 are PMOSs, and the third transistor 14 is an NMOS. However, the first transistor 11 and the second transistor 12 may be NMOSs, and the third transistor 14 may be a PMOS.

### Second Embodiment

FIG. 5 is a circuit diagram illustrating a configuration of a switching circuit according to a second embodiment.

A switching circuit is includes a high-side switch 3, a low-side switch 4, and a driver 7a. The switching circuit is configured in which the driver 7 of the switching circuit 1 shown in FIG. 1 is replaced by the driver 7a. The driver 7a is configured in which the INV 8 of the driver 7 shown in FIG. 1 is replaced by a NAND 22 and a short-circuit detector 17 is additionally provided. The other configurations are the same as those in the switching circuit 1 shown in FIG. 1.

In the driver 7a, a high-side control signal VH is inputted to a first transistor 11 and a second transistor 12 through the NAND 22 and INVs 9 and 10. The first and second transistors 11 and 12 are PMOSs, and connected in series between a power supply terminal 2 and an internal power supply line 13.

The source of the first transistor 11 is connected to the power supply terminal 2, and the drain is connected to a control terminal 18. The gate of the first transistor 11 is connected to the output of the INV 9. The source of the second transistor 12 is connected to the control terminal 18, and the drain is connected to the internal power supply line 13. The gate of the second transistor 12 is connected to the output of the INV 10.

A third transistor 14 is connected in parallel to the second transistor 12. The third transistor 14 is an NMOS; the drain thereof is connected to the control terminal 18, and the source is connected to the internal power supply line 13. The gate of the third transistor 14 is connected to the output of a NOR 15.

The NOR 15 generates an OR (a signal VD) between the output of the NAND 22 and a signal VR that the output of the NAND 22 is delayed at a delay circuit 16. The delay circuit 16 includes a resistor and a capacitor. The signal VD is a signal that the rising edge of the output of the NAND 22 is unchanged and only the falling edge is delayed and inverted. A delay time is set to a first period T1 that is almost equal to a reverse recovery time Trr of a parasitic diode DL of the low-side switch 4.

The short-circuit detector 17 detects a short circuit between an output terminal 5 and a ground terminal GND. In FIG. 5, the short-circuit detector 17 includes a D flip-flop (DFF). The signal VD is inputted to a clock terminal CK of the DFF, and an output voltage VLX is inputted to an input terminal D of the DFF. A short-circuit detecting signal VS is outputted to an output terminal Q of the DFF. The DFF of the short-circuit detector 17 is clocked at the rising edge of the signal VD.

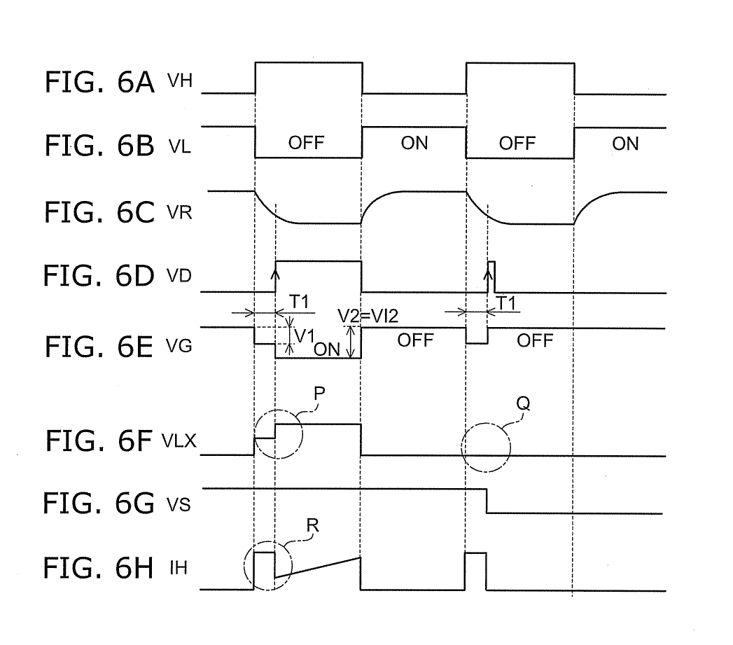

The NAND 22 generates a NAND between the high-side control signal VH and the short-circuit detecting signal VS. As explained in FIG. 6A to FIG. 6H, the NAND 22 masks the high-side control signal VH with the short-circuit detecting signal VS. The DFF forming the short-circuit detector 17 is set in a state in which a short circuit is not detected for the initial state, i.e. a state to output high level. It is also possible to provide a set terminal for the switching circuit is in order that the DFF is externally set and returned to the initial state.

The internal power supply line 13 is supplied with a voltage −VI2 with respect to the power supply terminal 2. VI2 is supplied as an internal supply voltage to the logic circuits such as the NAND 22 and the INVs 9 and 10 in the inside of the driver 7. The logic circuits in the inside of the driver 7a operate based on the potential of the internal power supply line 13.

As described above, the first transistor 11, the second transistor 12, and the third transistor 14 are connected to the control terminal 18. The driver 7a controls a gate voltage (the voltage of the control terminal) VG of the high-side switch 3 according to the high-side control signal VH and the output voltage VLX. The driver 7a outputs a low-side control signal VL to the gate of the low-side switch 4 as the logic is unchanged.

Next, the operation of the switching circuit is will be described.

FIG. 6A to FIG. 6H are timing charts of main signals of the switching circuit shown in FIG. 5. FIG. 6A shows the high-side control signal VH, FIG. 6B shows the low-side control signal VL, FIG. 6C shows the signal VR, FIG. 6D shows the signal VD, FIG. 6E shows the gate voltage VG, FIG. 6F shows the output voltage VLX, FIG. 6G shows the short-circuit detecting signal VS, and FIG. 6H shows a high-side current IH.

In FIG. 6B, indications ON and OFF express that the low-side switch 4 is controlled to be on or off, respectively. In FIG. 6E, indications ON and OFF express that the high-side switch 3 is controlled to be on or off, respectively.

In FIG. 6A to FIG. 6H, the case is illustrated where square waves periodically repeating high level and low level are inputted for the high-side control signal VH (FIG. 6A). The low-side control signal VL is a signal that the high-side control signal VH is inverted (FIG. 6B). It is noted that a dead time provided for preventing the high-side switch 3 and the low-side switch 4 from being turned on at the same time is omitted.

When the high-side control signal VH is at low level and the low-side control signal VL is at high level (FIG. 6A and FIG. 6B), the high-side switch 3 is off, and the low-side switch 4 is on. In this state, the output voltage VLX is at low level (FIG. 6F). The signal VD is at low level (FIG. 6D). The regenerated current of an inductive load 6 flows through the low-side switch 4.

When the low-side control signal VL is changed from high level to low level (FIG. 6B), the high-side control signal VH is changed from low level to high level (FIG. 6A). The low-side switch 4 is turned off, and the regenerated current flowing through the low-side switch 4 flowing through the parasitic diode DL.

Since the signal VD is delayed by the first period T1 with respect to the high-side control signal VH, the signal VD is at low level (FIG. 6D). Therefore, the short-circuit detecting signal VS is made at high level regardless of the output voltage VLX (FIG. 6G).

The first transistor 11 is turned off, the second transistor 12 is turned on, and the third transistor 14 is turned off. Since the second transistor 12 is a source follower output, the gate voltage VG of the high-side switch 3 is made at a first voltage V1 higher than the potential of the internal power supply line 13 by a threshold voltage Vth of the second transistor 12 (FIG. 6E). In FIG. 6E, the gate voltage VG is expressed based on the potential of the power supply terminal 2.

Here, the first voltage V1 is set lower than the internal supply voltage V12. An ON resistance Ron of the high-side switch 3 has a value greater than the value in the case of supplying the internal supply voltage V12. Thus, the reverse current of the parasitic diode DL is restricted to the ON resistance Ron, and flowing as the current IH of the high-side switch 3 (a portion surrounded by an alternate long and short dash line R in FIG. 6H).

The signal VR at the output of the delay circuit 16 is decreased according to a time constant (FIG. 6C). In the first period T1, the signal VR is decreased more than the logic threshold voltage of the NOR 15. The signal VD is changed to high level (FIG. 6D). The signal VD is made to a signal that the rising edge of the high-side control signal VH is delayed by the first period T1.

After the first period T1 since the high-side control signal VH is changed to low level, the signal VD is made at high level (FIG. 6D), and the DFF of the short-circuit detector 17 is clocked. In this state, the output voltage VLX is at high level (a portion surrounded by an alternate long and short dash line P in FIG. 6F). Thus, the short-circuit detector 17 does not detect a short circuit, and the short-circuit detecting signal VS remains at high level (FIG. 6G).

The third transistor 14 is turned on, and the gate voltage VG is made at a second voltage V2=−VI2. The output voltage VLX is increased to the supply voltage VIN (FIG. 6F). At this time, since the first period T1 elapses, which is almost equal to the reverse recovery time Trr of the parasitic diode DL, the reverse recovery current of the parasitic diode DL is already decreased. The current IH of the high-side switch 3 is almost linearly increased (FIG. 6H).

When the high-side control signal VH is changed to low level and the low-side control signal VL to high level, the high-side switch 3 is turned off and the low-side switch 4 is turned on. The similar operations are repeated after the subsequent cycle.

In the case where the output voltage VLX is at low level in the first period T1 (a portion surrounded by an alternate long and short dash line Q in FIG. 6F), the short-circuit detector 17 detects a short circuit, and outputs low level for the short-circuit detecting signal VS (FIG. 6G).

The short-circuit detecting signal VS at low level is inputted to the NAND 22, and the NAND 22 outputs high level. The signal VD is made at low level. The first transistor 11 is turned on, the second transistor 12 is turned off, and the third transistor 14 is turned off.

Consequently, the high-side switch 3 is turned off, and the current IH of the high-side switch 3 is made at 0 (FIG. 6H).

As described above, when the high-side control signal VH is at low level and the low-side control signal VL is at high level, the driver 7a turns off the high-side switch 3 and turns on the low-side switch 4. Thereby, the regenerated current of the inductive load 6 flows through the low-side switch 4.

When the high-side control signal VH is changed to high level and the low-side control signal VL to low level, the low-side switch 4 is turned off. At the same time, the first voltage V1 is supplied to the high-side switch 3 in the first period T1. At this time, the reverse recovery current of the parasitic diode DL of the low-side switch 4 restricted to the ON resistance Ron=Ron1 flows as the current IH of the high-side switch 3.

After the first period, the supply voltage VIN is supplied as the second voltage V2 higher than the first voltage V1 to turn on the high-side switch 3. The ON resistance Ron=Ron2 of the high-side switch 3 in this switching is made smaller than the value in the first period T1.

In the switching circuit 1a, a gate drive voltage is decreased in the first period T1 in which the high-side switch 3 is changed from off to on, so that the reverse recovery current of the parasitic diode DL is restricted. After the first period T1, the gate drive voltage of the high-side switch 3 is increased at some time when the current flowing through the parasitic diode DL is gone, and the ON resistance is more decreased.

After the first period T1 since the high-side control signal VH is changed from low level to high level, in the case where the output voltage VLX of the output terminal 5 remains at low level, the short-circuit detecting signal VS is made at low level. The NAND 22 outputs high level to turn off the high-side switch 3. It is possible to prevent an overcurrent from flowing continuously through the high-side switch 3, and it is possible to prevent destruction.

Even in the case where the output terminal 5 and the ground terminal GND are short-circuited to each other in the first period T1, the current IH flowing through the high-side switch 3 takes a value restricted by a relatively high ON resistance Ron=Ron1.

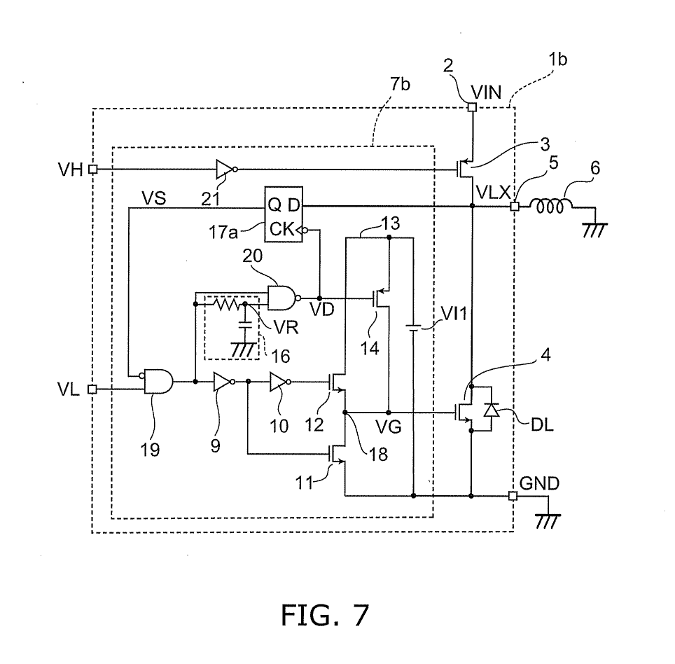

FIG. 7 is a circuit diagram illustrating another configuration of a switching circuit according to the second embodiment.

As illustrated in FIG. 7, a switching circuit 1b includes a high-side switch 3, a low-side switch 4, and a driver 7b. The switching circuit 1b is configured in which the driver 7a of the switching circuit is shown in FIG. 5 is replaced by the driver 7b. The high-side switch 3 and the low-side switch 4 are the same as those in the switching circuit is except that a first voltage V1 and a second voltage V2 are supplied to a gate (a control terminal) 18 of the low-side switch 4.

In the driver 7b, a low-side control signal VL is inputted to a first transistor 11 and a second transistor 12 through an AND 19, and INVs 9 and 10. The first and second transistors 11 and 12 are NMOSs, and connected in series between an internal power supply line 13 and a ground terminal GND.

The source of the first transistor 11 is connected to the ground terminal GND, and the drain is connected to the gate (the control terminal) 18 of the low-side switch 4. The gate of the first transistor 11 is connected to the output of the INV 9. The source of the second transistor 12 is connected to the control terminal 18, and the drain is connected to the internal power supply line 13. The gate of the second transistor 12 is connected to the output of the INV 10.

A third transistor 14 is connected in parallel to the second transistor 12. The third transistor 14 is a PMOS; the drain thereof is connected to the control terminal 18, and the source is connected to the internal power supply line 13. The gate of the third transistor 14 is connected to the output of a NAND 20.

The NAND 20 generates a NAND (a signal VD) between the output of the AND 19 and a signal VR that the output of the AND 19 is delayed at a delay circuit 16. The delay circuit 16 includes a resistor and a capacitor. The signal VD is a signal that the falling edge of the output of the AND 19 is unchanged and only the rising edge is delayed and inverted. As explained in FIG. 2A to FIG. 2G, FIG. 4A, and FIG. 4B, a delay time can be set to a first period T1, for example.

A short-circuit detector 17a detects a short circuit between an output terminal 5 and a power supply terminal 2. In FIG. 7, the short-circuit detector 17a includes a D flip-flop (DFF). The signal VD is inputted to a clock terminal CK of the DFF, and an output voltage VLX is inputted to an input terminal D of the DFF. A short-circuit detecting signal VS is outputted to an output terminal Q of the DFF. The DFF of the short-circuit detector 17a is clocked at the falling edge of the signal VD.

The AND 19 generates an AND between the low-side control signal VL and the NOT of the short-circuit detecting signal VS. As explained in FIG. 8A to FIG. 8G, the AND 19 is the NOT of the short-circuit detecting signal VS, and masks the low-side control signal VL. The DFF forming the short-circuit detector 17a is reset to a state in which a short circuit is not detected for the initial state, i.e. in a state to output low level. It is also possible to provide a reset terminal for the switching circuit 1b in order that the DFF is externally reset and returned to the initial state.

The internal power supply line 13 is supplied with a voltage VI1 with respect to the ground terminal GND. The voltage VI1 is supplied as a supply voltage to the logic circuits such as the AND 19 and the INVs 9 and 10 in the inside of the driver 7b. The logic circuits in the inside of the driver 7b operate based on the ground terminal GND.

As described above, the first transistor 11, the second transistor 12, and the third transistor 14 are connected to the control terminal 18. As explained in FIG. 8A to FIG. 8G, the driver 7b controls a gate voltage VG of the low-side switch 4 according to the low-side control signal VL and the output voltage VLX. The driver 7b inverts a high-side control signal VH at an INV 21, and outputs the high-side control signal VH to the gate of the high-side switch 3.

Next, the operation of the switching circuit 1a will be described.

FIG. 8A to FIG. 8G are timing charts of main signals of the switching circuit shown in FIG. 7. FIG. 8A shows the high-side control signal VH, FIG. 8B shows the low-side control signal VL, FIG. 8C shows the signal VR, FIG. 8D shows the signal VD, FIG. 8E shows the gate voltage VG, FIG. 8F shows the output voltage VLX, and FIG. 8G shows the short-circuit detecting signal VS.

In FIG. 8A to FIG. 8G, the case is illustrated where square waves periodically repeating high level and low level are inputted for the low-side control signal VL (FIG. 8B). The high-side control signal VH is a signal that the low-side control signal VL is inverted (FIG. 8A). It is noted that a dead time provided for preventing the high-side switch 3 and the low-side switch 4 from being turned on at the same time is omitted.

In FIG. 8A, indications ON and OFF express that the high-side switch 3 is controlled to be on or off, respectively. In FIG. 8E, indications ON and OFF express that the low-side switch 4 is controlled to be on or off, respectively.

When the high-side control signal VH is at high level and the low-side control signal VL is at low level (FIG. 8A, B), the high-side switch 3 is on, and the low-side switch 4 is off. In this state, the output voltage VLX is at high level (FIG. 8F). The signal VD is at high level (FIG. 8D).

When the high-side control signal VH is changed from high level to low level (FIG. 8A), the low-side control signal VL is changed from low level to high level (FIG. 8B). The high-side switch 3 is turned off.

Since the signal VD is delayed by the first period T1 with respect to the low-side control signal VL, the signal VD is at high level (FIG. 8D). Consequently, the short-circuit detecting signal VS is at low level regardless of the output voltage VLX (FIG. 8G).

The first transistor 11 is turned off, the second transistor 12 is turned on, and the third transistor 14 is turned off. Since the second transistor 12 is a source follower output, the gate voltage VG of the low-side switch 4 is made at the first voltage V1 lower than the internal supply voltage VI1 by a threshold voltage Vth of the second transistor 12 (FIG. 8E). In FIG. 8E, the gate voltage VG is expressed based on a ground potential of 0 V.

Here, the first voltage V1 is set lower than the internal supply voltage VI1. An ON resistance Ron of the low-side switch 4 has a value greater than the value in the case of supplying the internal supply voltage VI1. Thus, a current I1 of the low-side switch 4 is restricted to the ON resistance Ron.

The signal VR at the output of the delay circuit 16 is increased according to a time constant (FIG. 8C). In the first period T1, the signal VR is made higher than the logic threshold voltage of a NOR 15. The signal VD is changed to low level (FIG. 8D). The signal VD is made to a signal that the rising edge of the low-side control signal VL is delayed by the first period T1 and inverted.

After the first period T1 since the low-side control signal VL is changed to high level, the signal VD is made at low level (FIG. 8D), and the DFF of the short-circuit detector 17a is clocked. At this time, the output voltage VLX is at low level (a portion surrounded by an alternate long and short dash line P in FIG. 8F). Thus, the short-circuit detector 17a does not detect a short circuit, and the short-circuit detecting signal VS remains at low level (FIG. 8H).

The third transistor 14 is turned on, and the output voltage VLX is decreased to the ground potential at 0 V (FIG. 8F).

When the low-side control signal VL is changed to low level and the high-side control signal VH to high level, the low-side switch 4 is turned off, and the high-side switch 3 is turned on. The similar operations are repeated after the subsequent cycle.

In the case where the output voltage VLX is at high level in the first period T1 (a portion surrounded by an alternate long and short dash line Q in FIG. 8F), the short-circuit detector 17a detects a short circuit, and outputs high level (FIG. 8H).

The short-circuit detecting signal VS at high level is inputted to the AND 19, and the AND 19 outputs low level. The signal VD is made at high level. The first transistor 11 is turned on, the second transistor 12 is turned off, and the third transistor 14 is turned off.

Consequently, the low-side switch 4 is turned off.

As described above, when the high-side control signal VH is at high level and the low-side control signal VL is at low level, the driver 7b turns on the high-side switch 3 and turns off the low-side switch 4.

When the high-side control signal VH is changed to low level and the low-side control signal VL to high level, the high-side switch 3 is turned off. At the same time, the first voltage V1 is supplied to the low-side switch 4 in the first period T1. Thereby, a current IL of the low-side switch 4 is restricted to the ON resistance Ron=Ron1.

After the first period, the internal supply voltage VI1 is supplied as the second voltage V2 higher than the first voltage V1 to turn on the low-side switch 4. The ON resistance Ron=Ron2 of the low-side switch 4 in this switching is made smaller than the value Ron1 in the first period T1.

In the switching circuit 1b, the gate drive voltage is decreased in the first period T1 in which the low-side switch 4 is changed from off to on, so that the current of the low-side switch 4 is restricted. Thus, even in the case where the output terminal 5 and the power supply terminal 2 are short-circuited to each other, it is possible to prevent an overcurrent from flowing through the low-side switch 4, and it is possible to prevent destruction.

After the first period T1 since the low-side control signal VL is changed from low level to high level, in the case where the output voltage VLX of the output terminal 5 remains at high level, the short-circuit detecting signal VS is made at high level. The AND 19 outputs low level to turn off the low-side switch 4. Thus, it is possible to prevent an overcurrent from flowing continuously through the low-side switch 4, and it is possible to prevent destruction.

In the switching circuits 1, 1a, and 1b shown in FIG. 1, FIG. 5, and FIG. 7, respectively, the high-side switch 3 is a PMOS, and the low-side switch 4 is an NMOS. However, the high-side switch 3 may be an NMOS, and the low-side switch 4 may be a PMOS.

In the switching circuit 1b shown in FIG. 7, the first transistor 11 and the second transistor 12 are NMOSs, and the third transistor 14 is a PMOS. However, the first transistor 11 and the second transistor 12 may be PMOSs, and the third transistor 14 may be NMOSs.

In the switching circuits 1 and is shown in FIG. 1 and FIG. 5, respectively, the internal supply voltage −VI2 is supplied to the internal power supply line 13. However, it is also possible that the internal supply voltage −VI2 is not supplied and the internal power supply line 13 is connected to the ground terminal GND.

In the switching circuit 1b shown in FIG. 7, the internal supply voltage VI1 is supplied to the internal power supply line 13. However, it is also possible that the internal supply voltage VI1 is not supplied and the internal power supply line 13 is connected to the power supply terminal 2.

### Third Embodiment

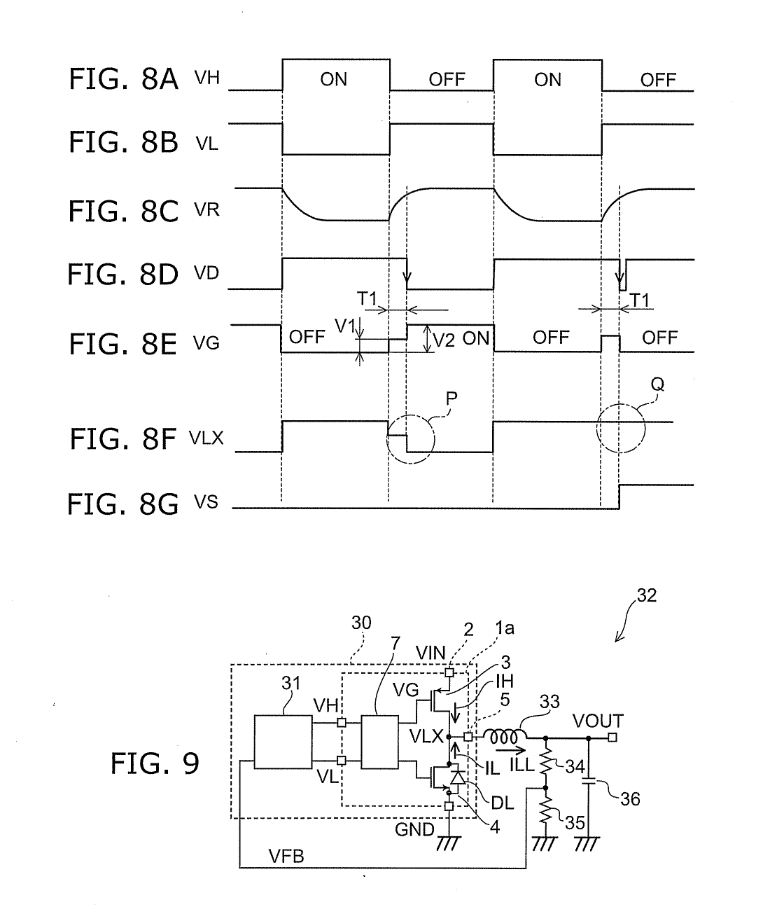

FIG. 9 is a circuit diagram illustrating a configuration of a DC-to-DC converter according to a third embodiment.

As illustrated in FIG. 9, in a DC-to-DC converter 32, a switching circuit 1a is additionally provided with a controller 31 that controls the switching circuit 1a. The switching circuit 1a is the same as the switching circuit 1a shown in FIG. 5.

In the DC-to-DC converter 32, one end of an inductor 33 is connected to an output terminal 5 of the switching circuit 1a. Feedback resistors 34 and 35 are connected in series between the other end of the inductor 33 and a ground terminal GND. A smoothing capacitor 36 is connected between the other end of the inductor 33 and the ground terminal GND.

The feedback resistors 34 and 35 feed back, to the controller 31, a voltage VFB that an output voltage VOUT at the other end of the inductor 33 is divided.

The controller 31 outputs a high-side control signal VH and a low-side control signal VL to the switching circuit 1a. The controller 31 controls the switching circuit is according to the output voltage VOUT at the other end of the inductor 33. FIG. 10A to FIG. 10G are timing charts of main signals of the DC-to-DC converter shown in FIG. 9. FIG. 10A shows the high-side control signal VH, FIG. 10B shows the low-side control signal VL, FIG. 10C shows a gate voltage VG, FIG. 10D shows an output voltage VLX of the switching circuit, FIG. 10E shows a high-side current IH, FIG. 10F shows a low-side current IL, and FIG. 10G shows an inductor current ILL.

In FIG. 10B, indications ON and OFF express that a low-side switch 4 is controlled to be on or off, respectively. In FIG. 10C, indications ON and OFF express that a high-side switch 3 is controlled to be on or off, respectively. A dead time Td is provided to prevent the high-side switch 3 and the low-side switch 4 from being turned on at the same time.

When the high-side control signal VH is at low level and the low-side control signal VL is at high level (FIG. 10A and FIG. 10B), the gate voltage VG of the high-side switch 3 is at high level (FIG. 10C). The high-side switch 3 is off, and the low-side switch 4 is on. In this state, the output voltage (the voltage of the output terminal 5) VLX of the switching circuit is at low level (FIG. 10D). The regenerated current IL equal to the current ILL of the inductor 33 flows through the low-side switch 4 (FIG. 10F and FIG. 10G).

When the controller 31 changes the high-side control signal VH from low level to high level and the low-side control signal VL from high level to low level (FIG. 10A and FIG. 10B), the low-side switch 4 is turned off. The regenerated current IL flowing through the low-side switch 4 flows through a parasitic diode DL.

The gate voltage VG is made at a first voltage V1 in a first period T1 (FIG. 10C). Here, as explained in FIG. 2A to FIG. 2G, the first voltage V1 is set lower than an internal supply voltage V12. An ON resistance Ron=Ron1 of the high-side switch 3 has a value greater than the value in the case of supplying the internal supply voltage V12. Thus, the reverse current of the parasitic diode DL is restricted to the ON resistance Ron=Ron1, and flowing as the current IH of the high-side switch 3 (a portion surrounded by an alternate long and short dash line R in FIG. 10E). The current ILL of the inductor 33 is increased (FIG. 10G).

After the first period T1 since the high-side control signal VH is changed to high level, a short-circuit detector 17 does not detect a short circuit because the output voltage VLX is at high level (a portion surrounded by an alternate long and short dash line P in FIG. 10D), and the gate voltage VG is made at a second voltage V2=−VI2 (FIG. 10C). The output voltage VLX of the switching circuit 1a is increased to a supply voltage VIN (FIG. 10D).

At this time, since the first period T1 elapses, which is almost equal to a reverse recovery time Trr of the parasitic diode DL, the reverse recovery current of the parasitic diode DL is already decreased. The current IH of the high-side switch 3 and the current ILL of the inductor 33 are almost linearly increased (FIG. 10E and FIG. 10G).

When the controller 31 changes the high-side control signal VH to low level and the low-side control signal VL to high level, the high-side switch 3 is turned off and the low-side switch 4 is turned on. The regenerated current ILL of the inductor 33 flows through the low-side switch 4 (FIG. 10F and FIG. 10G). The similar operations are repeated after the subsequent cycle.

In the case where the output voltage VLX is at low level in the first period T1 (a portion surrounded by an alternate long and short dash line Q in FIG. 10D), the short-circuit detector 17 detects a short circuit, and the gate voltage VG is made at high level (FIG. 10C). The high-side switch 3 is turned off, and the current IH of the high-side switch 3 is made at 0 (FIG. 10E).

As described above, in the DC-to-DC converter 32, when the high-side control signal VH is at low level and the low-side control signal VL is at high level, the high-side switch 3 is turned off and the low-side switch 4 is turned on. At this time, the regenerated current IL equal to the current ILL of the inductor 33 flows through the low-side switch 4.

When the high-side control signal VH is changed to high level and the low-side control signal VL to low level, the low-side switch 4 is turned off. At the same time, the first voltage V1 is supplied to turn on the high-side switch 3 in the first period T1. At this time, the reverse recovery current of the parasitic diode DL of the low-side switch 4 restricted to the ON resistance Ron=Ron1 flows as the current IH of the high-side switch 3.

After the first period, the supply voltage VIN is supplied as the second voltage V2 higher than the first voltage V1. The ON resistance Ron=Ron2 of the high-side switch 3 in this supply is made smaller than the value in the first period T1.

In the DC-to-DC converter 32, the gate drive voltage is decreased in the first period T1 in which the high-side switch 3 is changed from off to on, so that the reverse recovery current of the parasitic diode DL is suppressed. After the first period T1, the gate drive voltage of the high-side switch 3 is increased at some time when the current flowing through the parasitic diode DL is gone, and the ON resistance is more decreased.

After the first period T1 since the high-side control signal VH is changed from low level to high level, in the case where the output voltage VLX of the output terminal 5 remains at low level, a short circuit is detected, and high level is outputted to the gate drive voltage to turn off the high-side switch 3. It is possible to prevent an overcurrent from flowing continuously through the high-side switch 3, and it is possible to prevent destruction.

Even in the case where the output terminal 5 and the ground terminal GND are short-circuited to each other in the first period T1, the current IH flowing through the high-side switch 3 takes a value restricted by a relatively high ON resistance.

In FIG. 9, the configuration of the DC-to-DC converter 32 using the switching circuit is illustrated. However, it is also possible to configure the DC-to-DC converter using the switching circuits 1 and 1b. Namely, it is the configuration in which the switching circuit is shown in FIG. 9 is replaced by the switching circuit 1 shown in FIG. 1 or the switching circuit 1b shown in FIG. 7.

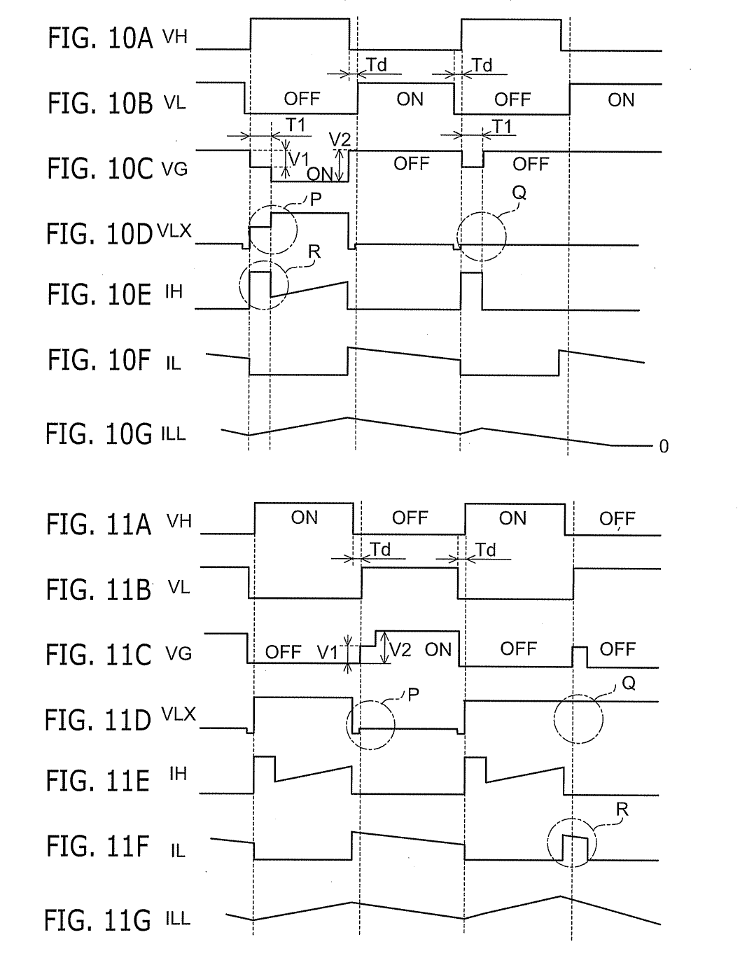

FIG. 11A to FIG. 11G are other timing charts of main signals of the DC-to-DC converter shown in FIG. 9. FIG. 11A shows the high-side control signal VH, FIG. 11B shows the low-side control signal VL, FIG. 11C shows the gate voltage VG, FIG. 11D shows the output voltage VLX of the switching circuit, FIG. 11E shows the high-side current IH, FIG. 11F shows the low-side current IL, and FIG. 11G shows the inductor current ILL.

In FIG. 11A to FIG. 11G, the main signals of the DC-to-DC converter using the switching circuit 1b are expressed.

In FIG. 11A, indications ON and OFF express that the high-side switch 3 is controlled to be on or off, respectively. In FIG. 11C, indications ON and OFF express that the low-side switch 4 is controlled to be on or off, respectively. A dead time Td is provided for preventing the high-side switch 3 and the low-side switch 4 from being turned on at the same time.

When the high-side control signal VH is at low level and the low-side control signal VL is at high level (FIG. 11A, B), the gate voltage VG of the low-side switch 4 is at low level (FIG. 11C). The high-side switch 3 is on, and the low-side switch 4 is off. In this state, the output voltage (the voltage of the output terminal 5) VLX of the switching circuit 1b is at high level (FIG. 11D). The regenerated current IL equal to the current ILL of the inductor 33 flows through the low-side switch 4 (FIG. 11F and FIG. 11G).

When the controller 31 changes the high-side control signal VH from high level to low level and the low-side control signal VL from low level to high level (FIG. 11A and FIG. 11B), the high-side switch 3 is turned off.

The gate voltage VG of the low-side switch 4 is made at the first voltage V1 in the first period T1 (FIG. 11C). Here, as explained in FIG. 8A to FIG. 8G, the first voltage V1 is set lower than the internal supply voltage V11. The ON resistance Ron of the low-side switch 4 has a value greater than the value in the case of supplying the internal supply voltage VI1. Thus, the current IL of the low-side switch 4 is restricted to the ON resistance Ron=Ron1 (FIG. 11F). The current ILL of the inductor 33 is decreased (FIG. 10G).

After the first period T1 since the low-side control signal VL is changed to high level, no short circuit is detected because the output voltage VLX is at low level (a portion surrounded by an alternate long and short dash line P in FIG. 11D), and the gate voltage VG is made at the second voltage V2=VI1 (FIG. 11C).

The output voltage VLX of the switching circuit 1b is decreased to the potential 0 V at the ground terminal GND (FIG. 11D).

The current IL of the low-side switch 4 and the current ILL of the inductor 33 are almost linearly decreased (FIG. 11F and FIG. 11G).

When the controller 31 changes the high-side control signal VH to high level and the low-side control signal VL to low level, the high-side switch 3 is turned on and the low-side switch 4 is turned off. The current IH flows through the high-side switch 3 due to the reverse recovery current Irr of the parasitic diode DL of the low-side switch 4 (FIG. 10E). The similar operations are repeated after the subsequent cycle.

In the case where the output voltage VLX is at high level in the first period T1 (a portion surrounded by an alternate long and short dash line P in FIG. 11D), a short circuit is detected, and the gate voltage VG is made at low level (FIG. 11C). The low-side switch 4 is turned off, and the current IL of the low-side switch 4 is made at 0 (FIG. 10F).

As described above, in the case of using the switching circuit 1b, the high-side switch 3 is turned on and the low-side switch 4 is turned off, when the high-side control signal VH is at high level and the low-side control signal VL is at low level. At this time, the current IH flows through the high-side switch 3 due to the reverse recovery current Irr of the parasitic diode DL of the low-side switch 4.

When the high-side control signal VH is changed to low level and the low-side control signal VL to high level, the high-side switch 3 is turned off. At the same time, the first voltage V1 is supplied to the low-side switch 4 in the first period T1. At this time, the current IL of the low-side switch 4 is restricted to the ON resistance Ron=Ron1.

After the first period, the internal supply voltage VI1 is supplied as the second voltage V2 higher than the first voltage V1 to turn on the low-side switch 4. The ON resistance Ron of the low-side switch 4=Ron2 in this switching is made smaller than the value in the first period T1.

As described above, the gate drive voltage is decreased in the first period T1 in which the low-side switch 4 is changed from off to on, so that it is possible to restrict a current flowing through the low-side switch 4. After the first period T1, the gate drive voltage of the low-side switch 4 is increased to decrease the ON resistance more.

Thus, after the first period T1 since the low-side control signal VL is changed from low level to high level, in the case where the output voltage VLX of the output terminal 5 is at high level, a short circuit is detected, and low level is outputted to the gate drive voltage to turn off the low-side switch 4. It is possible to prevent an overcurrent from flowing continuously through the low-side switch 4, and it is possible to prevent destruction.

Even in the case where the output terminal 5 and the power supply terminal 2 are short-circuited to each other in the first period T1, the current IL flowing through the low-side switch 4 takes a value restricted by a relatively high ON resistance.

The DC-to-DC converters using the switching circuits 1, 1a, and 1b are explained. However, for the switching circuit, the internal power supply line 13 may be connected to the ground terminal GND in the switching circuit 1 shown in FIG. 1 or the switching circuit 1a shown in FIG. 5. The internal power supply line 13 may be connected to the power supply terminal 2 in the switching circuit 1b shown in FIG. 7.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the invention.

What is claimed is:

1. A switching circuit comprising:
a high-side switch connected between a power supply terminal and an output terminal;
a low-side switch connected between the output terminal and a ground terminal; and
a driver configured to turn off any one of the high-side switch and the low-side switch according to a control signal, supply a first voltage to a control terminal of one other switch in a first period to turn on the one other switch, and supply a second voltage higher than the first voltage to the control terminal of the one other switch after the first period.

2. The circuit according to claim 1,
wherein the first period is not longer than a reverse recovery time of a parasitic diode of any one of the high-side switch and the low-side switch.

3. The circuit according to claim 1,
wherein the first period is not shorter than a reverse recovery time of a parasitic diode of any one of the high-side switch and the low-side switch.

4. The circuit according to claim 1,
wherein the first period is equal to a reverse recovery time of a parasitic diode of any one of the high-side switch and the low-side switch.

5. The circuit according to claim 1,
wherein a voltage difference between the second voltage and the first voltage is equal to a threshold voltage of a transistor.

6. The circuit according to claim 1,
wherein the driver turns off the one other switch when a short circuit of the output terminal is detected after the first period, and the driver supplies the second voltage to the one other switch when the short circuit of the output terminal is not detected after the first period.

7. The circuit according to claim 6,
wherein the driver supplies the first voltage to the high-side switch, and the driver turns off the high-side switch when a short circuit between the output terminal and the ground terminal is detected after the first period.

8. The circuit according to claim 6,
wherein the driver supplies the first voltage to the low-side switch, and the driver turns off the low-side switch to off when a short circuit between the output terminal and the power supply terminal is detected after the first period.

9. The circuit according to claim 6,
wherein the first period is not longer than a reverse recovery time of a parasitic diode of any one of the high-side switch and the low-side switch.

10. The circuit according to claim 6,
wherein the first period is not shorter than a reverse recovery time of a parasitic diode of any one of the high-side switch and the low-side switch.

11. A DC-to-DC converter comprising:
a switching circuit; and
a controller configured to control the switching circuit by outputting a control signal according to an inputted voltage,
the switching circuit including:
a high-side switch connected between a power supply terminal and an output terminal;
a low-side switch connected between the output terminal and a ground terminal; and
a driver configured to turn off any one of the high-side switch and the low-side switch according, to a control signal, supply a first voltage to a control terminal of one other switch in a first period to turn on the one other switch, and supply a second voltage higher than the first voltage to the control terminal of the one other switch after the first period.

12. The converter according to claim 11,
wherein the first period is not longer than a reverse recovery time of a parasitic diode of any one of the high-side switch and the low-side switch.

13. The converter according to claim 11,
wherein the first period is not shorter than a reverse recovery time of a parasitic diode of any one of the high-side switch and the low-side switch.

14. The converter according to claim 11,
wherein the first period is equal to a reverse recovery time of parasitic diode of any one of the high-side switch and the low-side switch.

15. The converter according to claim 11,
wherein a voltage difference between the second voltage and the first voltage is equal to a threshold voltage of a transistor.

16. The converter according to claim 11,
wherein the driver turns off the one other switch when a short circuit of the output terminal is detected after the first period, and the driver supplies the second voltage to the one other switch when the short circuit of the output terminal is not detected.

17. The converter according to claim 16,
wherein the driver supplies the first voltage to the high-side switch, and the driver turns off the high-side switch when a short circuit between the output terminal and the ground terminal is detected after the first period.

18. The converter according to claim 16,
wherein the driver supplies the first voltage to the low-side switch, and the driver turns off the low-side switch to off when a short circuit between the output terminal and the power supply terminal is detected after the first period.

19. The converter according to claim 16,
wherein the first period is not longer than a reverse recovery time of a parasitic diode of any one of the high-side switch and the low-side switch.

20. The converter according to claim 16,
wherein the first period is not shorter than a reverse recovery time of a parasitic diode of any one of the high-side switch and the low-side switch.
